(19) United States
(12) Patent Application Publication
(10) Pub. No.: US 2006/0087492 A1
(43) Pub. Date: Apr. 27, 2006

(54) Fixture device for a roller construction module

(75) Inventors: Li-Sen Chen, Gueishan Township (TW); Chien-Yu Hsu, Gueishan Township (TW); Chang-Yi Li, Gueishan Township (TW)

Correspondence Address: TROXELL LAW OFFICE PLLC, SUITE 1404, 5205 LEESBURG PIKE, FALLS CHURCH, VA, 22041, US

(73) Assignee: Speed Tech Corp.

(21) Appl. No.: 10/930,787

(22) Filed: Sep. 1, 2004

(51) Int. Cl. G09G 5/00

(52) U.S. Cl. 345/156

(57) ABSTRACT

The present invention is a fixture device for roller construction module, comprising a base plate and a frame. The frame comprises a containing hollow to contain the base plate; and protruding parts deposited on two opposite sides of the containing hollow. The base plate comprises fillisters deposited on two opposite sides of the base plate, which are corresponding to the two protruding parts of the frame; and a roller suspended by a support. Accordingly, the module can be easily positioned and assembled.

### FIELD OF THE INVENTION

The present invention relates to a fixture device; more particularly, relates to firmly fixing a roller construction module to a circuit board while the terminals of the roller construction module are prevented from being transformed by an external force.

### DESCRIPTION OF THE RELATED ART

The technology of mobile communication has progressed a lot during the past years so that the role of a roller construction module is becoming increasingly important. Traditionally, the prior art of a general navigation key as shown in FIG. 5 includes a roller construction module 51 in a body 50. The navigation key 5 is then set at the default place in the shell 6 of the electronic equipment and is covered by a cover 52 so that the navigation key 5 is set at the required place. When assembling the navigation key 5, the body 50 is set on the required circuit board and is to be electrically contacted with the circuit board by pressing the terminals (not by a welding fixture) while transferring the signals through a copper ring (an encoder) to the circuit board.

The above navigation key is capable of movements in three axes including rolling forward and backward, swaying leftward and rightward and moving downward. Yet, when assembling the navigation key 5, the positioning is not easy, the terminals are apt to be transformed, and the complexity of the production process cannot be simplified. Therefore, the prior art should be improved.

### SUMMARY OF THE INVENTION

The main object of the present invention is to provide a fixture device for easily positioning the roller construction module.

Another object of the present invention is to provide a fixture device for easily assembling the roller construction module.

The other object of the present invention is to provide a fixture device for the roller construction module to protect the terminals from being transformed by external force when operated by an end user pushing the module from expected position. To achieve the above-said objects, the present invention provides a fixture device for roller construction module comprising a base plate and a frame. The frame comprises a containing hollow to contain the base plate and two protruding parts extending from two opposite side surfaces of the containing hollow. The base plate comprising a roller movably jointed in the base plate; and fillisters set on two opposite sides of the base plate corresponding to the two protruding parts of the frame. Because the two protruding parts of the frame are disposed in the fillisters of the base plate, the roller of the base plate could be swayed. By these structures, the roller construction module can be firmly fixed on the circuit board so that the terminals can be prevented from being transformed by the external force and the production process can be simplified.

### BRIEF DESCRIPTIONS OF THE DRAWINGS

The present invention will be better understood from the following detailed description of preferred embodiments of the invention, taken in conjunction with the accompanying drawings, in which

FIG. 1 is a perspective view of the first embodiment according to the present invention;

FIG. 2 is a view showing the structure of the first embodiment according to the present invention;

FIG. 3 is a cross-sectional view showing the status of use according to the first embodiment of the present invention;

FIG. 4 is a view showing the structure of the second embodiment according to the present invention; and

FIG. 5 is a view of a navigation key according to the prior art.

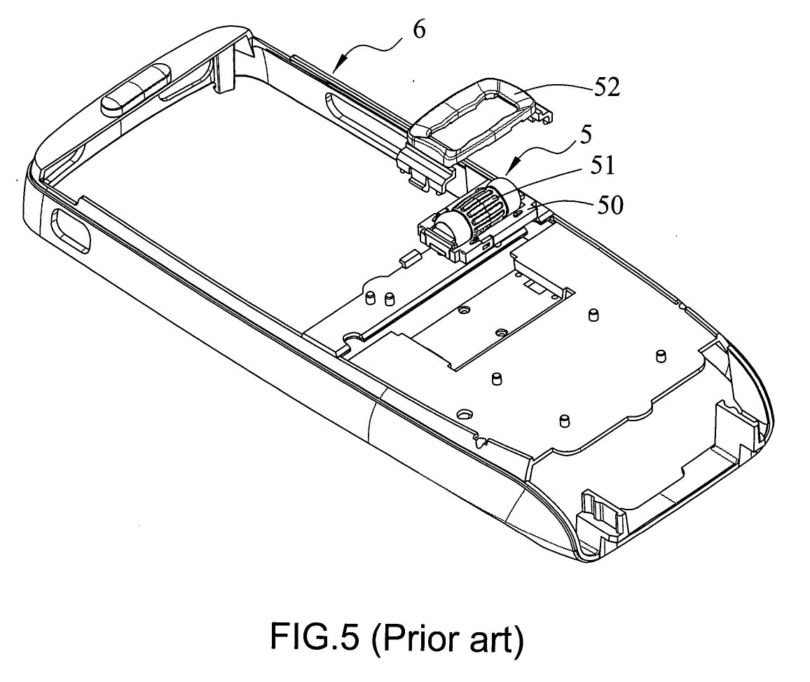

### DESCRIPTION OF THE PREFERRED EMBODIMENTS

The following descriptions of the preferred embodiments are provided to understand the features and the structures of the present invention.

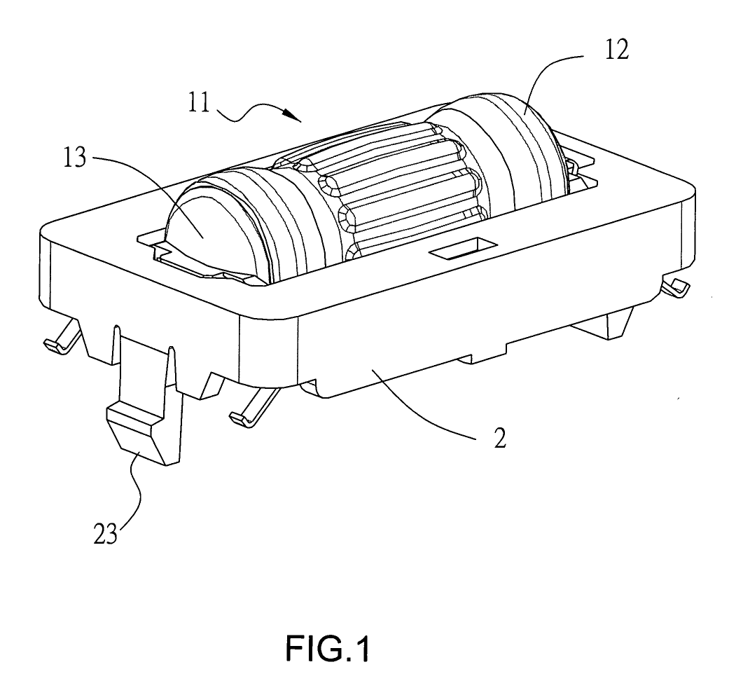

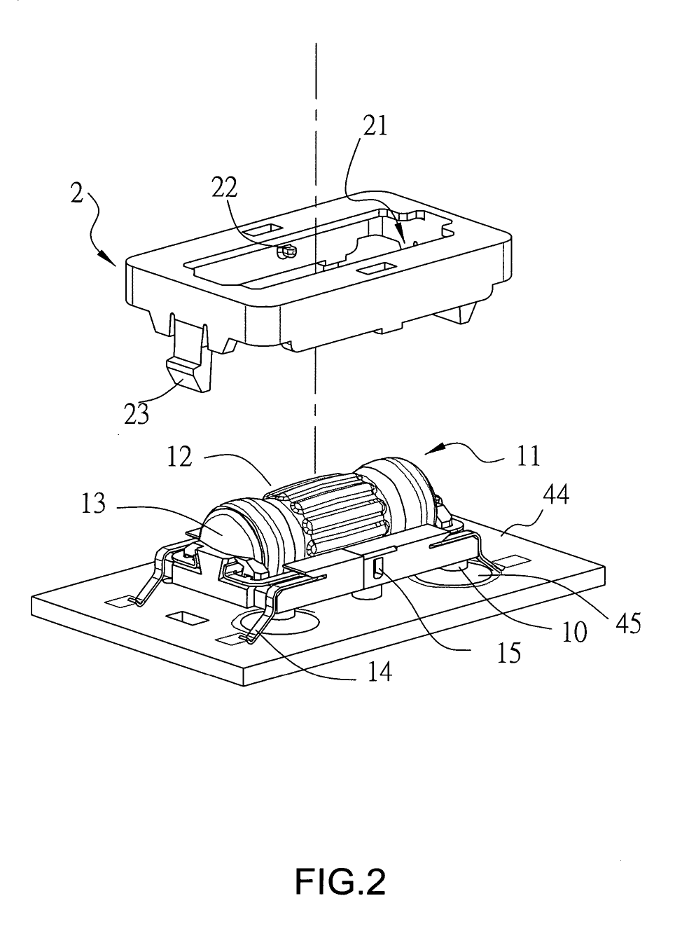

Please refer to FIG. 1 through FIG. 3, which are views of the first preferred embodiment according to the present invention. The present invention comprises a base plate 1 for a roller construction module, and a frame 2 which includes a containing hollow 21 to contain the above-said base plate 1 and two protruding parts 22 extended inwardly from two lateral opposite sides. The roller construction module mentioned above comprises the base plate 1 with a projections 10 extended downwardly from the bottom surface for pressing membrane switches 45; and a roller 11 having an insulation bushing 12, a support 13 firmly fastening the insulation bushing 12 on the base plate 1, and a plurality of terminals 14 which is extended into the inner hollow of the insulation bushing 12 and is electrically connected with the pads (not shown in the figures) on the circuit board.

The first preferred embodiment includes a roller construction module capable of movements in three axes, rolling forward or backward, swaying leftward or rightward, and pressing downward. The first preferred embodiment prevents the terminals 14 from being transformed by the external force when operated by an end user pushing the module from expected position. The base plate 1 of the first preferred embodiment further comprises fillisters 15 set on two opposite sides of the base plate 1 corresponding to the two protruding parts 22 of the frame 2. Because the protruding parts 22 of the frame 2 are disposed in the fillisters 15 of the base plate 1, the roller 11 of the base plate 1 could be swayed. When pressing the roller 11 downwardly along the direction perpendicular to the circuit board 44, the displacement between the protruding parts 22 of the frame 2 and the fillisters 15 of the base plate 1 must be loosely mated which means that this displacement allows the protruding parts 22 of the frame 2 and the fillisters 15 of the base plate 1 to be displaced in a small range. Besides, in the first embodiment, the frame 2 is made by plastic; but the frame 2 can be made of a transparent (or translucent) material.

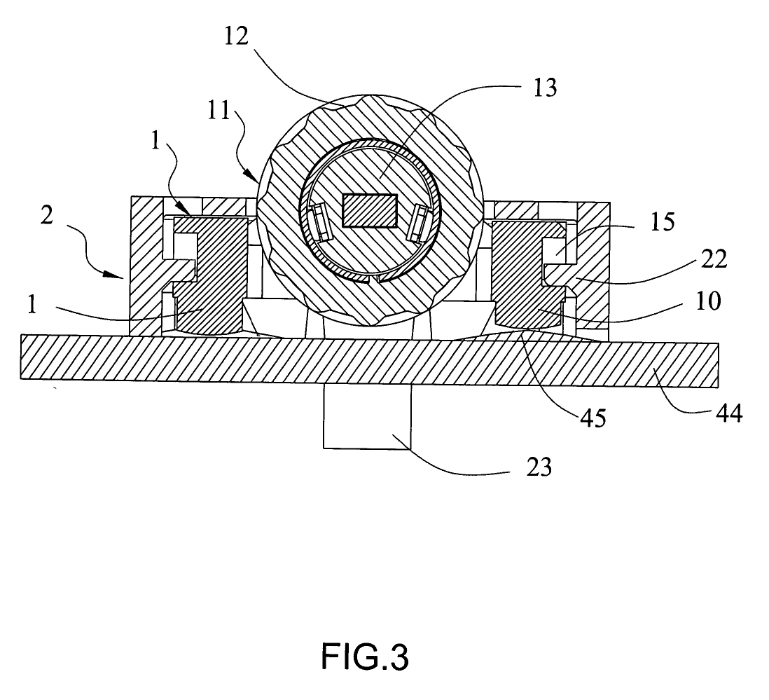

The frame 2 in the first preferred embodiment is fixed on a default position of the electronic equipment (not shown in the figures). In order to assembly the frame 2 to the circuit board 44 of the electronic equipment easily, at least one positioning fixture 23 is extended from the bottom surface of the frame 2 to plug through the circuit board 44. The positioning fixtures 23 can be a board lock locking the frame 2 onto the circuit board 44; and can be dissymmetrical to prevent the frame 2 from being misaligned to the circuit board 44 so that the assembly can be simplified. The electronic equipment can be a mobile network-communication device, such as a PDA, a mobile phone, a Smart Phone, etc. (not shown in the figures). After assembling the roller 11 to the base plate 1 and the frame 2, the roller construction module can be precisely and easily assembled to the circuit board 44. After assembling the whole roller construction module as shown in FIG. 3, the terminals 14 of the base plate 1 are electrically connected with the pads (not shown in the FIG. 3) on the circuit board 44. When the roller 11 is swayed leftward or rightward, or pressed downward, one of the projections of the bottom surface of the base plate 1 switches on one of the membrane switches 45, and the signals made by the membrane switch 45 are transmitted to the circuit board 44.

When the roller 11 is pressed, the terminals 14 and the membrane switches 45 are deformed; and then, later on, the status of the roller 11 is returned to the original status by the restoring force of the terminals 14 and that of the membrane switch 45.

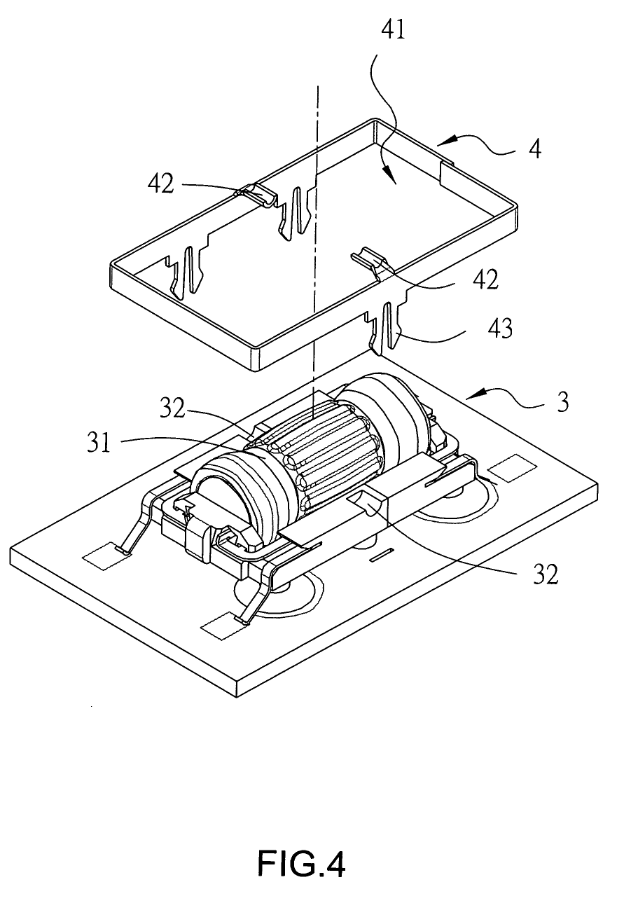

Please refer to FIG. 4, which is the second preferred embodiment according to the present invention. In the second preferred embodiment, the frame 4 is made by punching and bending a metal plate. In order to assembly the frame 4 to the circuit board 44 of the electronic equipment (not shown in the figure) easily, at least one positioning fixture 43 is extended from the bottom surface of the frame 4 to plug through the circuit board 44. The fillisters 32 of the base plate 3 are positioned at some proper positions on each of the two opposite sides of the base plate 3. The frame 4 of the second preferred embodiment includes a containing hollow 41 to contain the base plate 3. The protruding parts 42 are extended from the two opposite side surfaces of the frame 4 while being disposed into the fillisters 32. And, a plurality of positioning fixtures 43 is extending from the bottom surface of the frame 4. The positioning fixtures 43 can be a board lock locking the frame 4 onto the circuit board 44 and can be dissymmetrical to prevent the frame 4 from being misaligned to the circuit board 44 so that the assembly can be simplified.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A fixture device for roller construction module, comprising:
a base plate having a movably jointed roller and having fillisters on two opposite sides of said base plate; and
a frame having a containing hollow to contain said base plate and protruding parts on two opposite side surfaces of said containing hollow to be plugged into corresponding said fillisters.

2. The fixture device according to claim 1, wherein said fillister is a lengthwise fillister.

3. The fixture device according to claim 1, wherein said roller comprises an insulation bushing with an inner hollow; a support to fasten said insulation bushing; and a plurality of terminals plugged into said inner hollow from both end surfaces of said insulation bushing.

4. The fixture device according to claim 1, wherein said frame is made of a transparent plastic material.

5. The fixture device according to claim 1, wherein said frame is made of a translucent plastic material.

6. The fixture device according to claim 1, wherein said frame is made by punching and bending a metal plate.

7. The fixture device according to claim 1, wherein at least one positioning fixture is extended downwardly from the bottom surface of said frame to plug through a circuit board.

8. The fixture device according to claim 7, wherein said positioning fixtures are dissymmetrical on said bottom surface of said frame.
